(19) United States
(12) Patent Application Publication
(10) Pub. No.: US 2002/0072444 A1
(43) Pub. Date: Jun. 13, 2002

(54) Rocker joint silent chain

(76) Inventors: Kazumasa Matsuno, Osaka (JP); Shigekazu Fukuda, Osaka (JP); Hiroshi Horie, Osaka (JP); Yoshinori Iwasaki, Osaka (JP); Takayuki Funamoto, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/054,128

(22) Filed: Oct. 22, 2001

(30) Foreign Application Priority Data
Oct. 20, 2000 (JP) 321142/2000

(51) Int. Cl. F16G 13/04

(52) U.S. Cl. 474/215; 474/212; 474/213

(57) ABSTRACT

A rocker joint silent chain has guide link rows and articular link rows articulately connected by double rocker joint pins in an alternate fashion along the length of the chain. Guide link plates in each guide link row and articular link plate in each articular link row each have a pair of pin holes, and each of the double rocker joint pins is composed of a longer pin and a shorter pin that are inserted through each of the pin holes. The pin holes of at least the articular link plates have been subjected to a shaving process so as to improve the surface roughness and dimensional accuracies of inner peripheral surfaces of the pin holes. The longer and shorter pins have a hardened peripheral surface layer formed of a hard metal carbide of at least one of Cr, Ti, V, Nb and W. The double rocker joint pins and the shorter pins in particular are substantially free from local wear with the result that the wear elongation of the silent chain can be suppressed.

### BACKGROUND OF THE INVENTION

1. Field of the Invention

The present invention relates to a rocker joint silent chain having a plurality of interleaved rows of link plates articulately connected together by double rocker joint pins.

2. Description of the Related Art

Rocker joint silent chains are used for power transmission in a transfer of a four-wheel-drive vehicle or an automatic transmission. As shown here in FIGS. 3 and 4, a conventional rocker joint silent chain 21 includes guide link rows G and articular link rows K articulately connected by double rocker joint pins 27 in an alternate fashion along the length of the chain 21. Each of the double rocker joint pins 27 is composed of a longer pin 25 and a shorter pin 26 smaller in length than the longer pin 25. Each of the guide link rows G has a pair of guide plates 28, 28 and at least one guide link plate 24G (eight being shown) disposed between the guide plates 28. Each of the articular link rows K has at least two laterally aligned articular link plats 24K (ten being shown) interleaved with the guide link plates 24G of the adjacent guide links G. The guide plates 28 each have a pair of first non-circular pin holes 29 (FIG. 4), and the longer pin 26 of each double rocker joint pin 27 is firmly fitted in each of the first non-circular pin holes 29. The guide link plates 24G and the articular link plates 24K are identical in shape and configuration and each have a pair of second pin holes 22 and a pair of generally V-shaped teeth 23, as shown in FIG. 4. The longer and shorter pins 25 and 26 of each double rocker joint pins 25 are inserted through each of the second pin holes 22. Reference character 24S denotes plate springs 24S each disposed in one articular link row K so as to separate the articular link plates 24K into two groups.

The rocker joint silent chain 21 is trained around at least two sprockets (not shown) so as to perform power transmission between the sprockets via meshing engagement between inside flanks or outside flanks of the V-shaped teeth 23 of the link plates 24K, 24G and teeth of the sprockets.

As best shown in FIG. 5, the longer pin 25 and the shorter pin 26, jointly forming one rocker joint pin 27, have substantially the same transverse cross-sectional shape and include a convexly arcuate rolling surface R and a concavely arcuate seating surface W. The longer pin 25 and the shorter pin 26 received inside the second pin hole 22 are disposed in opposite relation with their rolling surfaces R, R held in contact with each other. The link plate shown in FIG. 5 is an articular link plate 24K.

Each of the pair of second pin holes 22 formed in the link plates 24K, 24G has a circular shape except a portion located adjacent to an end of each link plate 24K, 24G in the longitudinal direction of the chain 21. At this non-circular pin hole portion, the second pin hole 22 has a convexly arcuate seat surface 22A which operates to control the range of angular motion of the longer and shorter pins 25, 26 of each double rocker joint pin 27, as will be described later.

When the articular link plates 24K of one articular link row K come in mesh with the sprocket teeth (not shown), the rolling surface R of the shorter pin 26 in the same articular link row K rolls on the rolling surface R of the mating longer pin 25 being fixed at opposite ends to the guide plates in an adjacent guide link row G, allowing pivotal movement of the articular link plates 24K of the articular link row K relative to the guide link plates 24G of the adjacent guide link row K. In this instance, since there is a small gap or clearance between an inner peripheral surface of the second pin hole 22 of each articular link plate 24K and the longer and shorter pins 25, 26, the shorter pin 26 causes a repeated slight wobbling motion in the direction of the arrow shown in FIG. 5. The longer pin 25, which is firmly fitted at opposite ends in the non-circular holes 29 (FIG. 4) of the guide plates 28, causes such wobbling motion less frequently than the shorter pin 26.

The guide link plates 24G and the articular link plates 24K are identical in shape and configuration, as described above. Conventionally, the link plates 24G, 24K are produced from a sheet metal through a press-forming process. One example of such press-forming process is shown in FIG. 6, wherein a continuous blank strip B of flat steel or band steel is fed intermittently in a longitudinal direction successively through a first punching station ST1 and a second punching station ST2 disposed downstream of the first punching station ST. At the first punching station ST1, while the blank strip B is at rest, a pair of spaced punches P1, P2 (indicated by hatching for clarity) is reciprocated to form a pair of second holes 22, 22 in the blank strip B. Then, at the second punching station ST2, a profile cut punch P3 (indicated by hatching for clarity) is reciprocated to cut out the contour or profile of one link plate 24 from the blank strip B, thereby forming a link plate 24. In an alternative conventional press-forming process, the order of the afore-mentioned working steps is reversed. Namely, though not shown, at the first punching station, the profile of a link plate devoid of pin holes is cur out from a continuous blank strip, and at the second punching station, a pair of pin holes 22 is formed in the profile-cut link plate.

The longer and shorter pins 25, 26 are made of carbon steel and, in order to increase the wear resistance, they are subjected to a surface hardening, such as a carburizing process (which achieves a surface hardness of about 800 in Vickers scale), or a carbonitriding process (which achieves a surface hardness of about 850 in Vickers scale).

The conventional press-formed link plates 24G, 24K, as shown in FIG. 7, have a worked surface which is composed of a smooth sheared surface portion F and a rough ruptured or broken surface portion L. The proportion of smooth shear surface portion F is about 50% of the thickness of the link plate 24G, 24K (collectively designated by 24 in FIG. 7), so that the pin holes 22 in the link plate 24 are relatively low in accuracies. Particularly, the surface roughness of inner peripheral surfaces of the pin holes 22, the perpendicularity of the pin holes 22 with respect to a plane of each link plate, the positional accuracy of the pin holes 22 themselves and also relative to flanks of the V-shaped teeth 23, and parallelism of the inner peripheral surfaces of the pin holes 22 are relatively low.

Due to such relatively low accuracies of the pin holes 22, it occurs likely that the inner peripheral surface of each pin hole 22 and the longer and shorter pins 25, 26 of each double rocker joint pin 27 contact unevenly. Especially, when such uneven contact occurs between the seat surface 22A of the pin hole 22 and the concavely arcuate seating surface W of the shorter pin 26, the surface pressure between the seat and seating surfaces 22A and W increases locally, resulting in locally concentrated wear of the shorter pin 26 and accelerated wear of the peripheral surface of the pin hole 22. Furthermore, due to stress concentration caused by the uneven contact, the fatigue strengths of the double rocker joint pin 27 and link plates 24G, 24K are deteriorated, and the link plates 24G, 24K are likely to tilt in the axial direction of the double rocker joint pins 27. Tilting of the link plates 24G, 24K increases the contact pressure of the tooth flanks of the link plates 24G, 24K when mesh with the sprocket teeth, resulting in accelerated local wear of the tooth flanks and deterioration of the fatigue strength of the teeth flanks.

As previously described with reference to FIG. 5, due to a small gap or clearance existing between the peripheral surface of the pin hole 22 of the link plate 24K and the longer and shorter pins 25, 26, the shorter pin 26 is allowed to slightly wobble in the direction of arrow. As the slight wobbling movement of the shorter pin 26 is repeated during travel of the silent chain, the concavely arcuate seating surface W of the shorter pin 26 is susceptible to wear due to abrasion with the convexly arcuate seat surface 22A of the articular link plate 24K in the respective areas as indicated, for clarity, by hating and cross-hatching in FIG. 5. The seat surface 22A of the articular link plate 24K and the respective rolling surfaces R, R of the longer and shorter pins 25, 26 are almost free from wear.

The wear of the concavely arcuate seating surface W of the shorter pin 26 forms a main cause of wear elongation of the chain, which is considered to be a most significant problem associated with the rocker joint silent chains.

The link plates 24G, 24K treated with a surface hardening process have a surface hardness of about 550 Hv (Vickers hardness), while the shorter pin 26 hardened as described above has a surface hardness of about 850 Hv. In spite of the difference in the surface hardness, practical use of the silent chain indicated that wear appeared on the concavely arcuate seating surface W of the shorter pin 26 rather than on the convexly arcuate seat surface 22A of the pin hole 22 of the articular link plate 24K. As the wear elongation of the chain increases with the wear of shorter pin 26, the transmission efficiency of the chain becomes low and a noise is generated when the chain meshes with the sprocket. In a worse case, the silent chain may ride on the sprocket and jump the sprocket teeth.

Especially when the rocker joint silent chain is used for power transmission in a transfer of a four-wheel-drive vehicle or in an automatic transmission, the wear elongation of chain leads to enhanced operation noise and a reduced transmission efficiency, eventually producing a significant problem in which the chain rides on the sprocket and jumps over the sprocket teeth.

### SUMMARY OF THE INVENTION

It is accordingly a general object of the present invention to overcome the problems caused due to slight wobbling movement of shorter pins of the conventional rocker joint silent chain.

A more specific object of the present invention is to provide a rocker joint silent chain with improved link plates and double rocker joint pins which are able to suppress wear of double rocker joint pins caused due to uneven contact with the inner peripheral surfaces of pin holes, improve the wear resistance of the double rocker joint pins, prevent deterioration of the fatigue strength of the double rocker joint pins and link plates, and improve the surface roughness of the inner peripheral surface of the pin holes of articular link plates, the perpendicularity of the pin holes with respect to a plane of the corresponding link plate, the positional accuracy of the pin holes themselves and also relative to tooth flanks of the link plates, and the parallelism of the inner peripheral surfaces of the pin holes.

To achieve the foregoing objects, according to the present invention, there is provided a rocker joint silent chain comprising: guide link rows and articular link rows articulately connected by double rocker joint pins in an alternate fashion along the length of the chain, each of the double rocker joint pins being composed of a longer pin and a shorter pin smaller in length than the longer pin. Each of the guide link rows haa a pair of laterally spaced guide plates and at least one guide link plate disposed between the guide plates. Each of the articular link rows has at least two laterally aligned articular link plates interleaved with the guide link plate in each of the adjacent guide link rows. The guide plates each have a pair of first pin holes, the longer pin of each of the double rocker joint pins being firmly fitted in each of the first pin holes. The guide link plate and each of the articular link plates each have a pair of second pin holes, each of the double rocker joint pins composed of the longer and shorter pins being inserted through each of the second pin holes. Inner peripheral surfaces of the second pin holes of at least the articular link plates in each articular link row have been subjected to a shaving process so as to improve the surface roughness of the inner peripheral surfaces of the second pin holes, the perpendicularity of the second pin holes with respect to a plane of each of the articular link plates, the positional accuracy of the pin holes, and the parallelism of the inner peripheral surfaces of the second pin holes. The longer and shorter pins forming each of the double rocker joint pins each have a hardened peripheral surface layer formed of a hard metal carbide of at least one of Cr, Ti, V, Nb and W.

The term “shaving process” used herein refers to a finishing work or process achieved to remove uneven edges and rough surface portion L (FIG. 7) from the press-formed link plate by cutting off a slight layer from the outer peripheral surface of the link plate and the inner peripheral surfaces of the pin holes 22 in the same link plate by means of a pin-hole shaving mandrel (slightly larger in contour than the pin holes) and a profile shaving tool (slightly smaller in contour than the link plate) used in combination. The shaved peripheral surfaces of the link plate have improved surface roughness and dimensional accuracies.

It is preferable that inner peripheral surfaces of the second pin holes of the guide link plate in each guide link row have been also subjected to the shaving process.

The longer and shorter pins of each of the double rocker joint pins are preferably made of high-carbon steel containing 0.7 to 1.1% carbon. As an alternative, the longer and shorter pins may be made of low-carbon steel containing 0.1 to 0.4% carbon, in which instance the pins are subsequently carburized so as to have a hardened high-carbon surface layer containing 0.7 to 1.0% carbon. The pins made of high-carbon steel or the pin with a high-carbon steel surface layer are then treated at 900-1100° C. for 8 to 25 hours in a molten salt furnace or a powder kiln or furnace, so that a hardened surface layer formed of a hard metal carbide of at least one Cr, Ti, V, Nb and W is formed on the peripheral surfaces of the pins. The hardened surface layer thus formed has a surface hardness not less than 1600 Hv.

In the rocker join silent chain, since the pin holes in at least the link plates of the articular link rows have shaved inner peripheral surfaces with improved surface roughness and dimensional accuracies, the contact surface area between the inner peripheral surfaces of the link plate pin holes and the longer and shorter pins of each double rocker joint pin increases to an extent that uneven contact between the pin hole peripheral surfaces and the longer and shorter pins does not occur. As a result, the surface pressure between the shaved pin hole peripheral surfaces the longer and shorter pins becomes smaller than that of the conventional silent chain even when the chain is subjected to a constant tension. Thus, wear of the pin hole peripheral surfaces and the double rocker joint pins can be reduced.

Furthermore, while the silent chain is traveling around the sprockets for power transmission, the seating surfaces of the double rocker joint pins are stably seated on the seat surfaces of the link plate pin holes without causing wobbling movement. Thus, a local increase in the surface pressure between the pin hole peripheral surfaces and the double rocker joint pins does not occur with the result that the double rocker joint pins are substantially free from local wear. The rocker joint pins and the link plates are also free from stress concentration and hence can maintain the desired fatigue strength throughout the length of a service life. The link plates with shaved pin holes are substantially free from tilting in the axial direction of the rocker joint pins, so that the shaved teeth flanks of the link plate teeth can engage the sprocket teeth stably and smoothly without causing a local increase in the surface pressure which may result in deterioration of the fatigue strength of the link plates.

The double rocker joint pins having a hardened surface layer are highly resistant to wear. Furthermore, since the hardened surface layer is very hard and chemically stable, the affinity of the hardened surface layer with the pin hole peripheral surfaces is very low. Accordingly, even when the rocker joint silent chain is operating under boundary lubrication (i.e., in a lubricating condition that is a combination of solid-to-solid contact with a liquid-film shear), sticking or seizure is hard to occur between the rocker pins and the pin hole peripheral surfaces. Additionally, by virtue of the hardened surface layer, the amount of wear of the rocker pins is extremely small and hence can minimize the wear elongation of the silent chain.

Especially when the rocker pins are made of high-carbon steel containing 0.7 to 1.0% carbon, the affinity between the outer peripheral surface of the rocker pins and a hardened surface layer made of a hard metal carbide is very high. This ensure that the hardened surface layer can be produced stably and reliably with desired hardness and strength.

### BRIEF DESCRIPTION OF THE DRAWINGS

A preferred embodiment of the present invention will now be described in detail, by way of example only, with reference to the accompanying drawings, in which:

FIG. 1 is a plan view of a link plate used in a rocker joint silent chain according to an embodiment of the present invention;

FIG. 2 is a transverse cross-sectional view of a shorter pin of a double rocker joint pin of the rocker joint silent chain;

FIG. 3 is a fragmentary plan view, with parts broken away for clarity, of a conventional rocker joint silent chain;

FIG. 4 is a side view of the conventional silent chain;

FIG. 5 is an enlarged view illustrative of the manner in which wear occurs on the shorter pin of a double rocker joint pin inserted through an articular link row;

FIG. 6 is a diagrammatical view showing a typical conventional press-forming process used for forming link plates;

FIG. 7 is an enlarged cross-sectional view showing the structure of a punched surface of the conventional link plate; and

FIG. 8 is a graph showing the relation between the elongation and the running time that are taken in conjunction with inventive silent chains and conventional silent chains.

### DETAILED DESCRIPTION OF THE PREFERRED EMBODIMENT

The following description is merely exemplary in nature and is in no way intended to limit the invention or its application or uses.

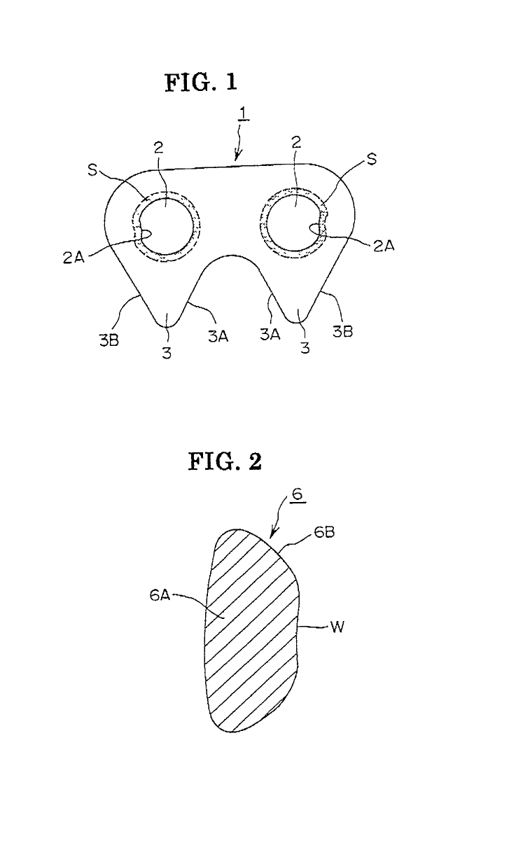

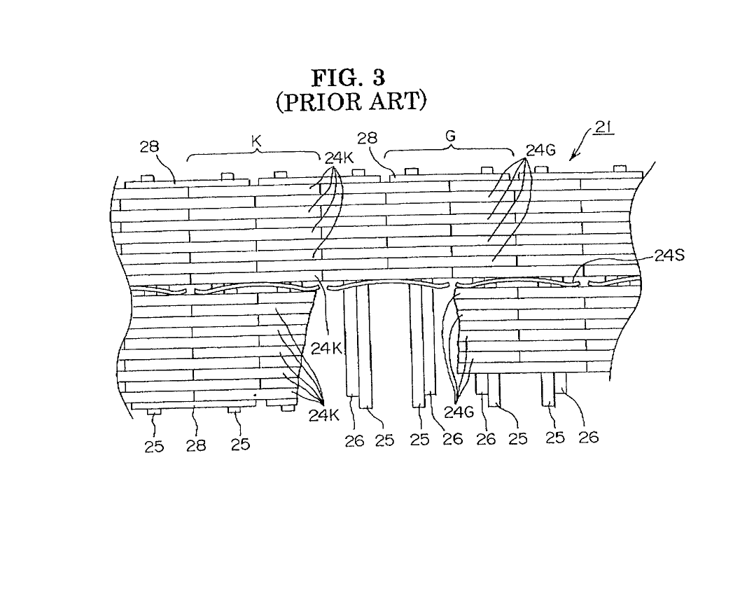

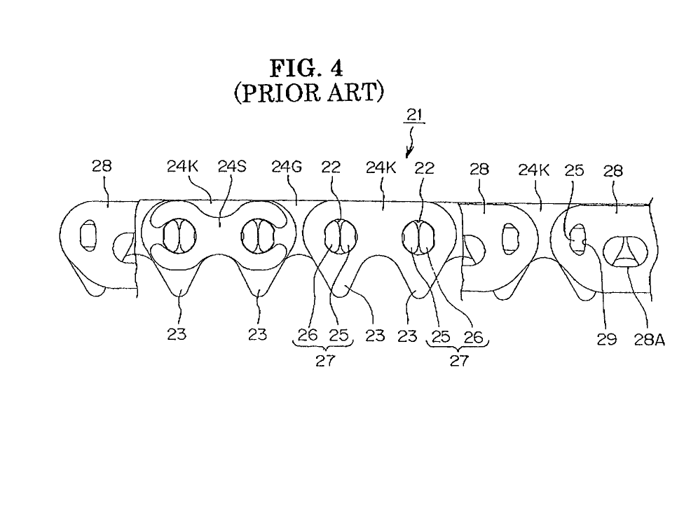

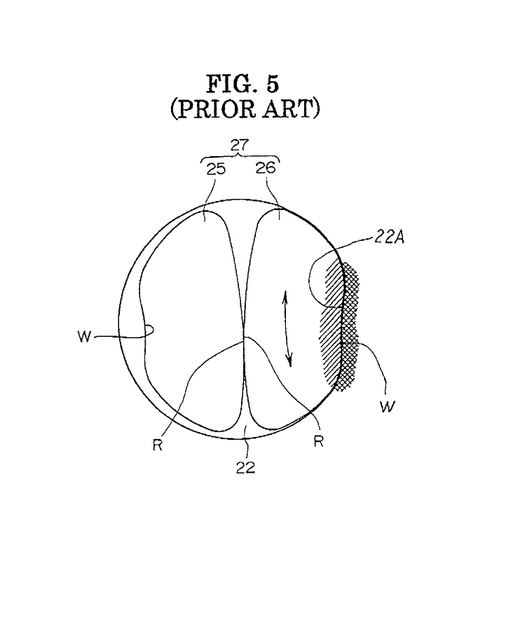

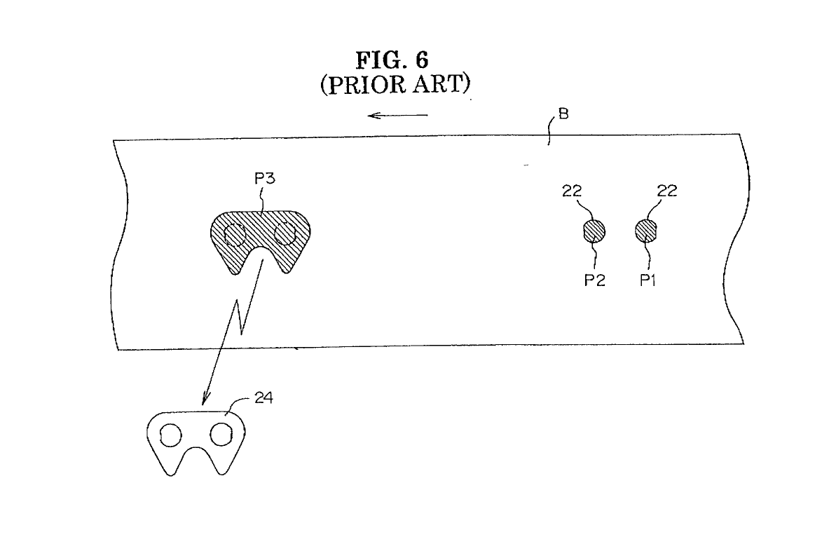

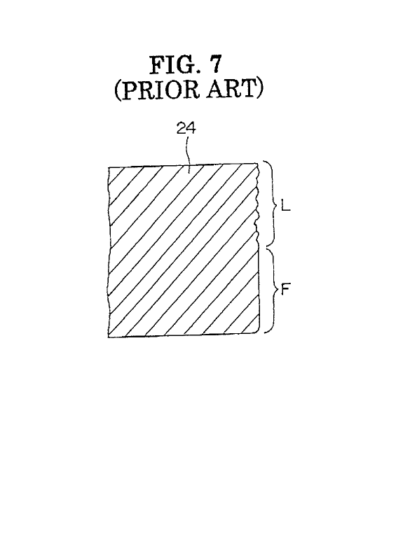

FIG. 1 shows in plan view a link plate 1 used in both guide link rows and articular link rows of a rocker joint silent chain of the present invention. Though not shown, the general structure of the inventive silent chain is substantially the same as the general structure of the conventional rocker joint silent chain described above with reference to FIGS. 3 and 4. It can readily be appreciated that the guide link rows and the articular link rows are arranged alternately in the longitudinal direction of the chain, and link plates in each guide link tow and link plates in an adjacent articular link row are interleaved and articulately connected by a double rocker joint pin composed of a longer pin and a shorter pin smaller in length than the longer pin.

As shown in FIG. 1, the link plate 1 has a pair of pin holes 2 and a pair of generally V-shaped teeth 3 at opposite ends. The pin holes 2 have a circular shape except a portion located adjacent to an end of the link plate 1, the non-circular pin hole portion has a convexly arcuate seat surface 2A connected at opposite ends to a circular peripheral surface portion of each pin hole 2.

The link plate 1 is press-formed from a blank material of flat steel or band steel, followed by a shaving process achieved to form a shaved smooth surface across more than 70% of the thickness of the link plate 1. In FIG. 1, the shaved pin holes 2 are indicated in an exaggerated manner by using half-toned annular areas S.

The longer and shorter pins jointly forming one of the double rocker joint pins have substantially the same cross-sectional shape including a convexly arcuate rolling surface and a concavely arcuate seating surface located opposite to the rolling surface. The longer and shorter pins are inserted through each of the shaved pin holes 2 back-to-back with their rolling surfaces being in rolling contact with each other. FIG. 3 shows a cross-sectional shape of the longer or shorter pin 6. The pin 6 is made of high-carbon steel 6A containing 0.7 to 1.0% carbon and has a hardened surface layer 6B of 6 to 20 μm in thickness formed on the peripheral surface of the high-carbon steel 6A. The hardened surface layer 6B is formed by a hard chromium (Cr) carbide and has a surface hardness not less than 1600 Hv (Vickers hardness).

The hardened surface layer 6B should by no means be limited to the Cr carbide but may include a hard metal carbide of titanium (Ti), vanadium (V), niobium (Nb), tungsten (W) or a combination thereof. When viewed from the microscopic metallic structure, the hard metal carbide may be of a single-phase formed solely by one of the metals specified above, or of a multi-phase formed by two or more of the metal carbides specified above. Typical examples of such hard metal carbide and their surface hardnesses are as follows: Cr23C6 (1660 Hv), Cr7C3 (1880 Hv), TiC (2900-3200 Hv), VC (2800 Hv), NbC (2400 Hv) and WC (2400 Hv).

The shaving process may be effected on inside and outside flanks 3A and 3B (FIG. 1) of the V-shaped teeth 3 of the link plate 3 that are used for meshing engagement with teeth of a sprocket (not shown).

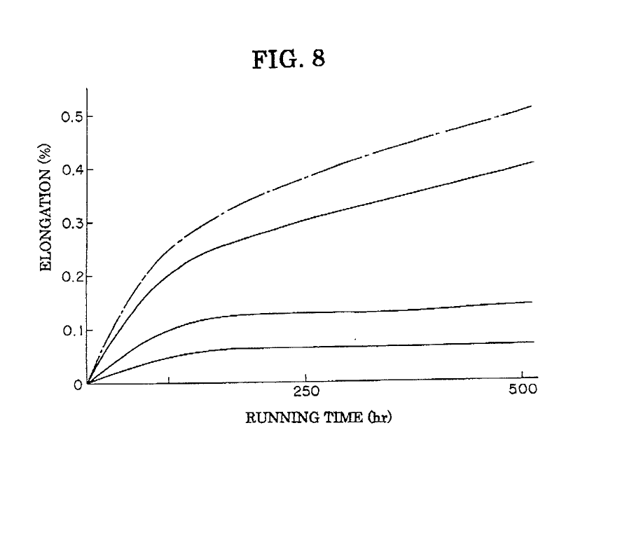

FIG. 8 is a graph showing the elongation characteristics experimentally determined in conjunction with inventive rocker joint silent chains and comparative rocker joint silent chains.

In a comparative test, two inventive silent chains of different properties and two comparative silent chains of different properties were used.

A first one of the inventive silent chains had rows of interleaved link plates articulately connected by double rocker joint pins each composed of a longer pin and a shorter pin. The link plates each had a pair of pin holes which had been shaved across approximately 70% of the thickness of the link plates. The longer and shorter pins had a 6 to 20 μm thick hardened surface layer of Cr7C3 with surface hardness of 1880 Hv formed on the peripheral surface of the material of pin made of high-carbon steel containing 0.7 to 1.0% carbon. The elongation characteristic of the first inventive silent chain is indicated by a curve I-1 shown in FIG. 8.

The second inventive silent chain was different from the first inventive silent chain only in that the hardened surface layer of each pin was composed of a Cr23C6 layer with surface hardness of 1660 Hv. The elongation characteristic of the second inventive silent chain is indicated by a curve I-2 shown in FIG. 8.

A first one of the comparative silent chains had rows of interleaved link plates articulately connected by double rocker joint pins each composed of a longer pin and a shorter pin. The link plates each had a pair of pin holes which had been shaved across approximately 70% of the thickness of the link plates. The longer and shorter pins had a hardened surface with surface hardness of 800 to 850 Hv formed by a carburizing process on the peripheral surface of the material of each pin made of low-carbon steel containing 0.1 to 0.3% carbon. The elongation characteristic of the first comparative silent chain is indicated by a curve C-1 shown in FIG. 8.

The second comparative silent chain was different from the first comparative silent chain only in that the shaving process effected on the pin holes in the press-formed link plates of the first comparative silent chain was omitted. The elongation characteristic of the second comparative silent chain is indicated by a curve C-2 shown in FIG. 8. The second comparative silent chain corresponds to the conventional silent chain.

It appears clear from FIG. 8 that the elongation at a 500 hours running time of the first comparative silent chain, as indicated by the curve C-1, reaches 0.4% and further increasers gradually as the time goes on. The second comparative silent chain, as indicated by the curve C-2, shows an elongation of 0.5% at a 500 hours running time, and the elongation further increases gradually as the time goes on.

As opposed to the comparative silent chains, the first inventive silent chain shows only an elongation of 0.05 at a 500 hours running time, as indicated by the curve I-1 in FIG. 8. This elongation is only 10% of the elongation of the second comparative silent chain. After the elongation reaches 0.05%, it remains substantially constant regardless of the running time. The elongation at a 500 hours running time of the second inventive silent chain is 0.15%, which is larger than the corresponding elongation of the first inventive silent chain but is about 40% of the second comparative silent chain. No substantial increase in the elongation is observed after the elongation reaches 0.15%.

It is experimentally proved that a practically satisfactory result can be obtained when a shaving process is effected on the inside peripheral surfaces of the pin holes across about 70% or greater of the thickness of the link plate with a depth of cut or shaving of about 0.1 mm.

In the embodiment described above, the pin holes of all of the link plates are subjected to the shaving process. It is enough for practical use that the shaving process is effected on the pin holes of at least the link plates of the articular link rows.

The high-carbon steel containing 0.7 to 1.1% carbon used as the material for the rocker pins may be replaced with a low-carbon steel containing 0.1 to 0.4% carbon which is carburized to form a hardened surface layer containing 0.7 to 1.1% carbon.

As described above, the rocker joint silent chain according to the present invention includes articular link plates with pin holes shaved to improve the surface roughness and dimensional accuracies of inner peripheral surfaces of the pin holes, By thus shaving the pin holes, it is possible to increase the contact surface area between the peripheral surface of each pin hole and a longer and a shorter pin of each double rocker joint pin to such an extent as to preclude the occurrence of uneven contact between the pin hole peripheral surface and the longer and shorter pins. This ensures that a concavely arcuate seating surface of the shorter pin is seated on a convexly arcuate seat surface of the pin hole stably and reliably without producing a local increase in the surface pressure between the seating and seat surfaces. In addition, since no substantive clearance is provided between the pin hole peripheral surface and the shorter pin, the shorter pin cannot wobble within the pin hole. This can suppress wear of the shorter pin.

Furthermore, by virtue of uniform contact between the double rocker joint pin and the pin hole peripheral surface insures, the rocker joint pin and the link plates are substantially free from deterioration of the fatigue strength.

The hardened surface layer formed by a hard metal carbide of at least one of Cr, Ti, V, Nb and W significantly increases the wear resistance of the longer and shorter pins of the double rocker joint pins. Wear on the seating surface of each pin is very small, and the rolling surface of the pin is substantially free from abrasive wear.

The wear suppressing effect attained by the hardened peripheral surface layer of the shorter pin and the wear suppressing effect attained by the shaved pin holes in the link plates are added or combined with each other. With the wear suppressing effects thus combined, the double rocker joint pins and the shorter pins in particular are substantially free from abrasive wear. This ensures that the wear elongation of the rocker joint silent chain is extremely low and the silent chain can operates smoothly and reliably even when subjected to severe tensile loads. The silent chain can maintain high dimensional accuracies over a long period of use.

Since the hardened surface layers of the longer and shorter pins are chemically stable and have an extremely high surface hardness, the affinity of the hardened surface layers with respect to the peripheral surfaces of the pin holes is low. Thus, sticking or seizure of the pin hole peripheral surfaces and the double rocker joint pins is unlikely to occur even when the silent chain is operating under boundary lubrication.

Furthermore, the high-carbon steel containing 0.7 to 1.1% carbon used as a material of the longer and shorter pins shows a good affinity with a hardened surface layer to be formed on the peripheral surface of the material of the pins. The hardened surface layer is chemically stable and can suppress wear of the rocker joint pins.

Obviously, various minor changes and modifications of the present invention are possible in the light of the above teaching. It is therefore to be understood that within the scope of the appended claims, the present invention may be practiced otherwise than as specifically described.

What is claimed is:

1. A rocker joint silent chain comprising:
guide link rows and articular link rows articulately connected by double rocker joint pins in an alternate fashion along the length of the chain, each of the double rocker joint pins being composed of a longer pin and a shorter pin smaller in length than the longer pin;
each of the guide link rows having a pair of laterally spaced guide plates and at least one guide link plate disposed between the guide plates;
each of the articular link rows having at least two laterally aligned articular link plates interleaved with the guide link plate in each of the adjacent guide link rows;
the guide plates each having a pair of first pin holes, the longer pin of each of the double rocker joint pins being firmly fitted in each of the first pin holes;
the guide link plate and each of the articular link plates each having a pair of second pin holes, each of the double rocker joint pins composed of the longer and shorter pins being inserted through each of the second pin holes,
wherein inner peripheral surfaces of the second pin holes of at least the articular link plates in each of the articular link rows have been subjected to a shaving process so as to improve the surface roughness of the inner peripheral surfaces of the second pin holes, the perpendicularity of the second pin holes with respect to a plane of each of the articular link plates, the positional accuracy of the second pin holes, and the parallelism of the inner peripheral surfaces of the second pin holes, and
wherein the longer and shorter pins forming each of the double rocker joint pins each have a hardened peripheral surface layer formed of a hard metal carbide of at least one of Cr, Ti, V, Nb and W.

2. The rocker joint silent chain according to claim 1, wherein the second hin holes of the articular link plates have respective shaved inner peripheral surfaces across not less than 70% of the thickness of the articular link plates.

3. The rocker joint silent chain according to claim 1, wherein inner peripheral surfaces of the second pin holes of the guide link plate in each of the guide link rows have been also subjected to the shaving process.

4. The rocker joint silent chain according to claim 3, wherein the second hin holes of the link plates in the guide and articular link rows have respective shaved inner peripheral surfaces across not less than 70% of the thickness of the link plates.

5. The rocker joint silent chain according to claim 1, wherein the hardened peripheral surface layer of the longer and shorter pins has a hardness number not less than 1600 in Vickers scale.

6. The rocker joint silent chain according to claim 5, wherein the hardened peripheral surface layer has a thickness of 6 to 20 μm.

7. The rocker joint silent chain according to claim 5, wherein the hardened peripheral surface layer is formed by Cr23C6, Cr7c3, TiC, VC, NbC, WC or a combination of thereof.

8. The rocker joint silent chain according to claim 7, wherein the hardened peripheral surface layer has a thickness of 6 to 20 μm.

9. The rocker joint silent chain according to claim 1, wherein the material of the longer and shorter pins is made of high-carbon steel containing 0.7 to 1.1% carbon.

10. The rocker joint silent chain according to claim 1, wherein the material of the longer and shorter pins is a carburized low-carbon steel containing 0.1 to 0.4% carbon and having a carburized peripheral surface layer containing 0.7 to 1.1% carbon.
